(19) United States
(12) Patent Application Publication
(10) Pub. No.: US 2017/0045175 A1
(43) Pub. Date: Feb. 16, 2017

(54) Method And Apparatus For Replacing Culverts

(71) Applicants: Earth Tool Company LLC, Lake Mills, WI (US); Aecon Group, Inc., Toronto (CA)

(72) Inventors: William Geoffrey Clarke, Huntsville (CA); Steven W. Wentworth, Fountain Hills, AZ (US)

(21) Appl. No.: 15/234,682

(22) Filed: Aug. 11, 2016

Related U.S. Application Data
(60) Provisional application No. 62/203,487, filed on Aug. 11, 2015.

(51) Int. Cl. F16L 55/168; F16L 55/18; F16L 1/028

(52) U.S. Cl. CPC F16L 55/168; F16L 1/028; F16L 55/18

(57) ABSTRACT

A system for installing a drainage structure in the subsurface. The system has a casing, a drive device, and at least one fin. The casing has opposed first and second ends and defines a hollow region. The drive device is supported at the first end of the casing and configured to drive movement of the casing in a first direction. The at least one fin projects from the casing into the hollow region and is configured to buckle a corrugated metal culvert positioned at least partially within the casing when the casing is driven in the first direction. The drive device may be a pneumatic hammer or puller attached to a rod pulling machine.

### CROSS REFERENCE TO RELATED APPLICATION

This application claims the benefit of U.S. Provisional Patent Application Ser. No. 62/203,487 filed on Aug. 11, 2015, the entire contents of which are incorporated herein by reference.

### FIELD

This invention relates generally to a method and apparatus for replacing drainage culverts.

### SUMMARY

The invention is directed to an assembly used to replace drainage culverts. The assembly comprises a casing, a drive device, and a first fin. The casing has opposed first and second end and defines a hollow region. The drive device is supported at the first end of the casing and is configured to drive movement of the casing in a first direction. The drive device may comprise a pneumatic hammer supported on the first end of the casing. The first fin projects from the casing into the hollow region and is configured to buckle a culvert pipe positioned at least partially within the casing when the casing is driven in the first direction.

### BRIEF DESCRIPTION OF THE DRAWINGS

FIG. 1 is an illustration of a drainage culvert positioned in the subsurface under a portion of a railroad track.

FIG. 2 is a side view of the drainage culvert of FIG. 1.

FIG. 3 is the partially sectional side view of FIG. 2 showing a culvert crushing assembly of the present invention.

FIG. 4 is a close-up view of the structure contained within detail C of FIG. 3.

FIG. 5 is a cross-section view of the assembly of Figure .4 taken along line 5-5.

FIG. 6 is a perspective view of a fin used in the culvert crushing assembly.

FIG. 7 illustrates the culvert crushing assembly partially advanced through the subsurface with a portion of the drainage culvert crushed.

FIG. 8 is a close-up view showing detail F of FIG. 4.

FIG. 9 is a close-up view showing detail E of FIG. 7.

FIG. 10 is a side view of the culvert crushing assembly after it has traversed the entire length of the drainage culvert.

FIGS. 11A and 11B are cross-sectional views of buckled drainage culverts.

FIG. 12 is a partially sectional side view of a casing installed around a crushed drainage culvert and an assembly for removing the culvert from the casing.

FIG. 13 is a perspective view of the mounting frame of the assembly of FIG. 12.

FIG. 14 is a perspective view of a second drive device comprising a linear winch.

FIG. 15 is a perspective view of the mounting frame and second drive device used to remove the drainage culvert from the casing.

FIG. 16 provides a perspective view of a towing member used with the assembly shown in FIG. 12.

FIG. 17 provides a perspective view of a pneumatic hammer adapted to push a deformed drainage culvert from the casing.

FIG. 18 is a perspective view of an alternative assembly used to pull a casing into the ground to envelope a drainage culvert.

FIG. 19 is a front perspective view of the trench box of FIG. 18.

FIG. 20 is a front, top perspective view of a rod puller that may be used with the assembly shown in FIG. 18.

FIG. 21 is a side, partially sectional, view of the casing being pulled into the ground by using a rod string.

FIG. 22 is a front perspective view of a casing puller.

FIG. 23 is a side view showing the buckled drainage structure within a sectional casing

FIG. 24 is a side, partially sectional, view showing the buckled drainage structure and a sweeper puller connected to the end of the rod string and used to pull the buckled drainage structure from the casing.

FIG. 25 is a perspective view of a sweeper puller of FIG. 24.

### DETAILED DESCRIPTION

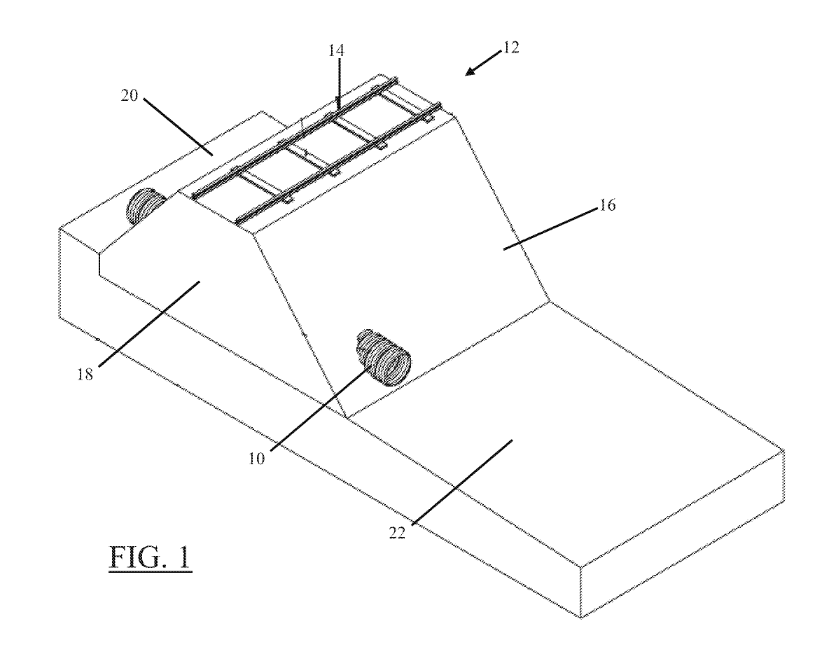

With reference now to the drawings in general, and FIG. 1 in particular, the general environment in which the culvert replacement method and apparatus described herein are used is shown. FIG. 1 shows a corrugated metal culvert 10 positioned to conduct surface water under a surface obstruction 12 to reduce the likelihood of flooding and erosion. The obstruction 12 may be a roadway or an elevated railroad track 14.

Corrugated metal culverts have proven reliable and resistant to collapse and corrosion. However, many culverts were installed over fifty (50) years ago and have exceeded the useful life of the metal. Typically, the culverts that fail have done so due to rust that leads to loss of hoop integrity. Loss of hoop integrity results in loss of load carrying capacity and potential collapse of the road or railroad track. Culvert failure can also cause loss of flow through the culvert which may cause increased erosion and flooding.

Replacing a failed culvert can be difficult because they are often positioned under busy roads, railroads, or located in remote areas. Shutting down the road or the track to replace the failed culvert is often not a viable option. For this reason, the method and apparatus disclosed herein is useful for replacement of culverts without the need to close a road or railroad track.

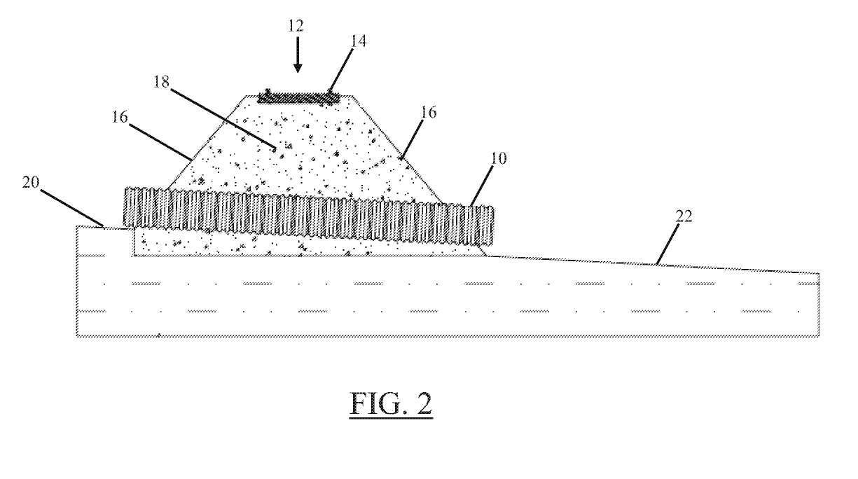

In FIGS. 1 and 2, a culvert 10 is installed under an elevated railroad track 14. The elevated track 14 is characterized by sloping sides 16 and ballast 18. The ballast 18 may be comprised of stable rock, dirt, or other material used to elevate the railway. Surface water may gather on the uphill side of elevated railway 14 on a collection plane 20 which extends for an indeterminate distance. When the culvert 10 functions properly, water collected on collection plane 20 flows through culvert 10 and continues to drain across downhill plane 22. If the culvert 10 becomes clogged or collapses surface water will not be able to drain from collection plane 20 to downhill plane 22. Therefore, a method and apparatus for replacing the culvert 10 without disrupting the surface obstruction 12 is preferred.

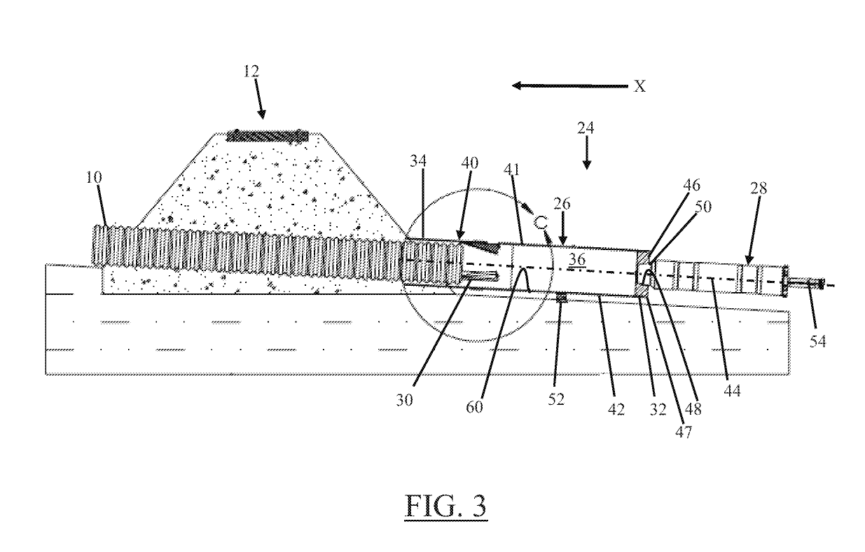

Turning now to FIG. 3, the culvert crushing assembly 24 of the present invention is shown in a partially sectional side view. The assembly 24 comprises a casing 26 (sown in section), a drive device 28, and at least one fin 30.

The assembly is shown with two fins 30 in FIG. 3 because casing 26 has been sectioned for purposes of illustration. If not sectioned, the casing 26 of FIG. 3 would have three (3) fins 30. The casing 26 has opposing first 32 and second 34 ends. The second end 34 is the leading edge of the casing and the first end 32 is the trailing end of the casing. The casing 26 defines a hollow region 36 that extends from end-to-end. The drive device 28 is supported at the first end 32 of the casing 26 and configured to drive movement of the casing in a first direction X. The fins 30 project radially from the inner surface 60 of the casing 26 into the hollow region 36. The fins are configured to buckle the culvert 10 as the casing is driven in the first direction.

Referring now to FIGS. 3, 4 and 5, the casing 26 may be circular in cross section, symmetric about a longitudinal axis 44, and made from steel. The casing 26 may comprise a crushing tool section .40 that is welded or otherwise attached to a leading end 41 of a casing segment 42. The leading edge of crushing tool section 40 defines the second end of the casing. The crushing tool section 40 is preferably of the same outside diameter as the rest of the casing 26, but may have a different wall thickness. In configurations where the wall thickness of the crushing tool section 40 is different than the wall thickness of the casing segment 42, the crushing tool may have a different inner diameter than the casing segment.

Fins 30 are attached to the inner surface 60 and project into the hollow region 36. The fins 30 are supported proximate the second end 34 of the casing 26. Specifically, the fins 30 may be supported by the casing 26 a distance from the second end 34 equal to approximately one (1) to three (3) times an internal diameter of the casing. As shown in FIG. 5, the three (3) fins 30 may be positioned about the longitudinal axis 44 and offset equally by an angle α of 120 degrees.

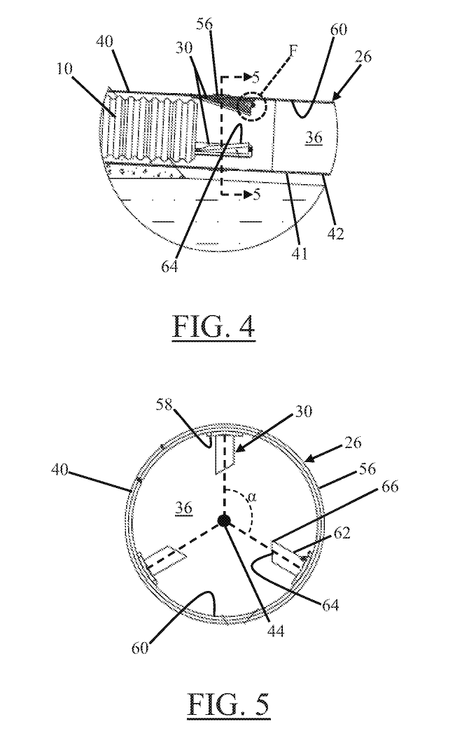

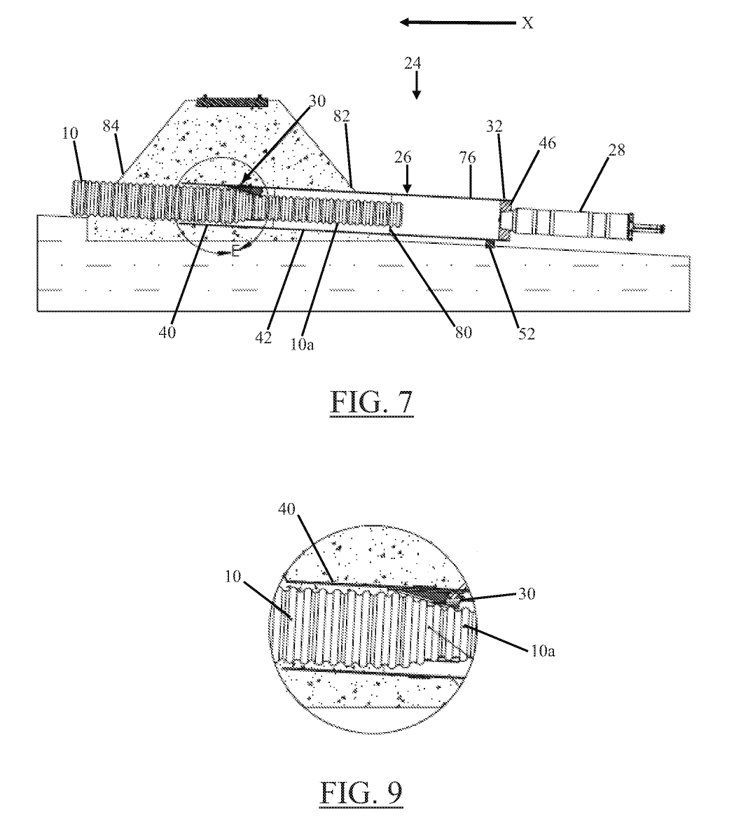

As shown in FIG. 4 each fin 30 tapers toward the second end 34 of the casing 36. Therefore, each fin 30 has a ramp profile. As shown in FIGS. 7 and 9, the ramp profile of each fin 30 causes the culvert 10 to yield under the force of the fin as the casing is moved in direction X. The culvert will be deformed so the cross-sectional profile of the culvert is a non-round shape to facilitate later extraction from the casing 26.

Movement of the casing 26 and fins 30 in direction X produces radial forces on the crushing tool 40. Therefore, a steel band 56 disposed about the crushing tool 40 may be welded to its outside surface at the approximate midpoint of the fins 30 to reinforce the crushing tool 40. The steel band 56 also over-expands the soil and reduces friction on casing 26 as increasing length is installed into the ground. As shown, the steel band 56 can be placed to provide both reinforcement against radial forces generated by the fins 30 and reduce friction on the casing 26. Steel band 56 is preferably positioned on the crushing tool 40 where the highest is radial force is exerted on the casing; i.e. where the crushing process encounters maximum material strength.

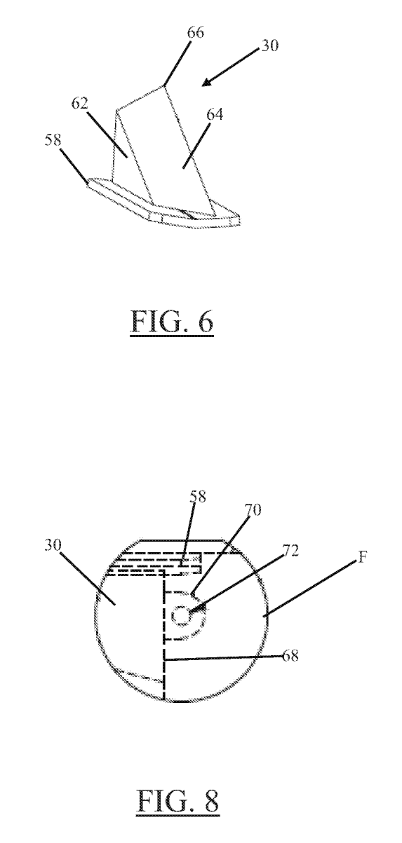

With reference now to FIGS. 4, 5, and 6, the fins 30 will be discussed in more detail. As illustrated. in FIG. 4, the fins 30 are elongate and taper toward the second end 34 of the casing 26. Each fin 30 may have a foot 58 (FIG. 6) for securing the fin to the inner surface 60 of the casing 26. Each foot 58 may have a contour that conforms to the curve of the inner surface 60 of the casing 26. The foot 58 supports a fin body 62 that extends from the foot into the hollow regions 36. The fin body terminates at a crushing surface 6.4 that extends for the entire length of the fin body 62. The crushing surface 64 is sloped along its length and terminates at an edge 66. The edge 66 is narrow to reduce friction and may be heat treated for hardness or hard faced. Additionally, a friction reducing material may be welded to the crushing surface 64. As shown in FIG. 9, the narrow edge 66 contacts the culvert 10 to apply the crushing force which deforms the culvert,

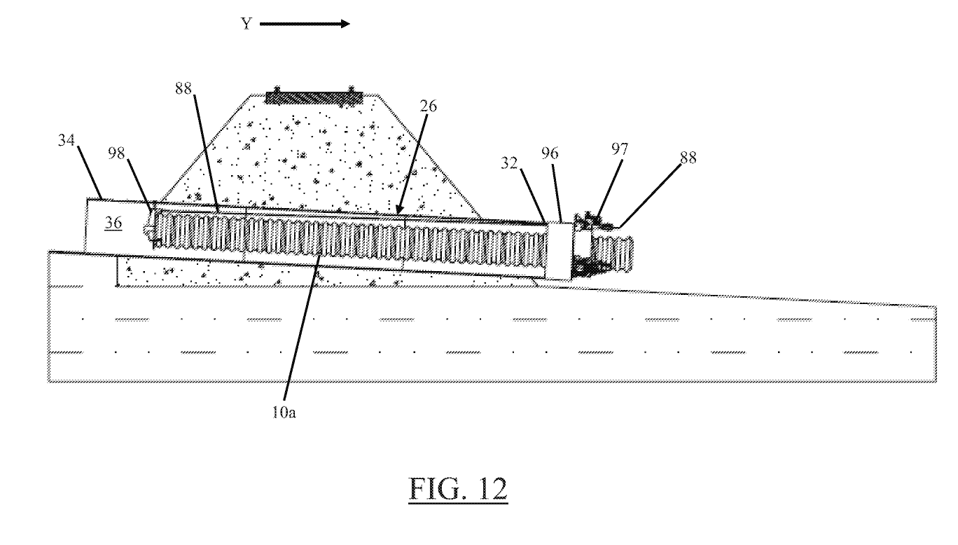

Turning now to FIG. 8, a detail F view of the fin from FIG. 4 is provided. The fin 30 comprises a back wall 68. The back wall 68 of each fin may be fitted with a towing eye 70 having an eyelet 72. The towing eye 70 and eyelet 72 are configured for attachment to a wire rope 88 (FIG. 12) for a purpose discussed with reference to FIG. 12. The towing eye 70 may be made from steel and welded or bolted to the back wall 68 of the fin 30. Therefore, the back wall of each fin 30 must be of sufficient width to permit attachment of the towing eye 70.

Returning to FIG. 3, a segmented sleeve 46 is demountably supported within the first end 32 of the casing 26. The segmented sleeve 46 may comprise collets that are wedged into the casing. The segmented sleeve 46 has a shoulder 47 that abuts the edge of the casing 26. The sleeve 46 has three segments that define a tapered inner diameter 48. The inner diameter 48 is configured to receive a portion of the nose 50 of the drive device 28. As the drive device 28 operates to push the casing in direction X, it forces each segment of the sleeve outward into the inner wall of the casing. This action firmly seats the sleeve 46 in the casing and transfers the axial force generated by the drive device 28 to the casing in direction X.

Axial alignment between the casing 26 and the culvert 10 is maintained by a support member 52. The support member 52 may be an elongate rail positioned on the ground in an orientation that is perpendicular to the longitudinal axis 44 of the casing. Support member 52 maybe made from timber, metal, or any other material capable of withstanding the weight and friction forces generated during operation of the drive device 28 and movement of the ca sing 26 in the first direction X. More than one support member 52 may be placed under the casing 26 to support the casing in alignment with the desired grade and with the culvert 10. Use of support member 52 also helps to prevent binding or excessive friction when the drive device 28 is pushing the casing in the first direction X. As an alternative to support member 52, the casing and drive device 28 may be supported on rails (not shown) installed on the ground parallel to the longitudinal axis 44 of the casing.

The drive device 28 shown in FIG. 3 is a pneumatic hammer The pneumatic hammer has a tapered nose 50 and is powered by air fed to the hammer by hoses 54. Acceptable hammers for use in the present embodiment are HammerHead® Rammers manufactured by Earth Tool Company L.L.C. In operation, the pneumatic hammer receives pressurized air from an air compressor (not shown). The compressed air is transported to the hammer by hoses 54 where it is used to drive reciprocal operation of the hammer. The size and diameter of the drive device 28 used may depend of the diameter of the casing 26 to be installed. Acceptable drive devices 28 may range in size from four inches (4″) to thirty-four inches (34″) in diameter.

Turning now to FIG. 7, the assembly 24 of the present invention is shown with the casing 26 advanced into the subsurface and around a crushed portion of the culvert 10. FIG. 9, provides a close-up view of the crushing tool portion 40 contained within circle E of FIG. 7. The assembly is engaged with and crushing the culvert 10.

In FIG. 7, the casing section 42 has been advanced in direction X from the position shown in FIG. 3 so that it partially surrounds a crushed portion of the culvert 10. A second casing section 76 has been attached to the trailing end of section 42. The second section 76 may be attached to section 42 by welding the two sections together at seam 80. Upon the addition of second section 76, the segmented sleeve 46 and drive device 28 are repositioned within the trailing end of section 76. The new section 76 has been driven into the subsurface such that the first end 32 of the casing 26 has reached the support structure 52. A new section will be added to the first end 32 to continue progress of the culvert replacement operation.

In operation, the casing section 42 and crushing tool 40 are driven into the subsurface by the drive device 28 until the first end 32 of the casing 26 reaches the entry position 82. The drive device 28 and segmented sleeve are 46 are removed from the casing 26 and pulled back a sufficient distance to allow section 76 to be positioned adjacent to section 42. Section 76 is aligned with section 42 and the culvert 10 using support 52. It is then welded to section 42 at seam 80. The segmented sleeve 46 and drive device 28 are installed in section 76 and the operation to drive the casing in direction X resumes. Thus, when a new casing section is attached to the casing as shown in FIG. 7, the trailing end of the new section becomes the first end 32 of the casing.

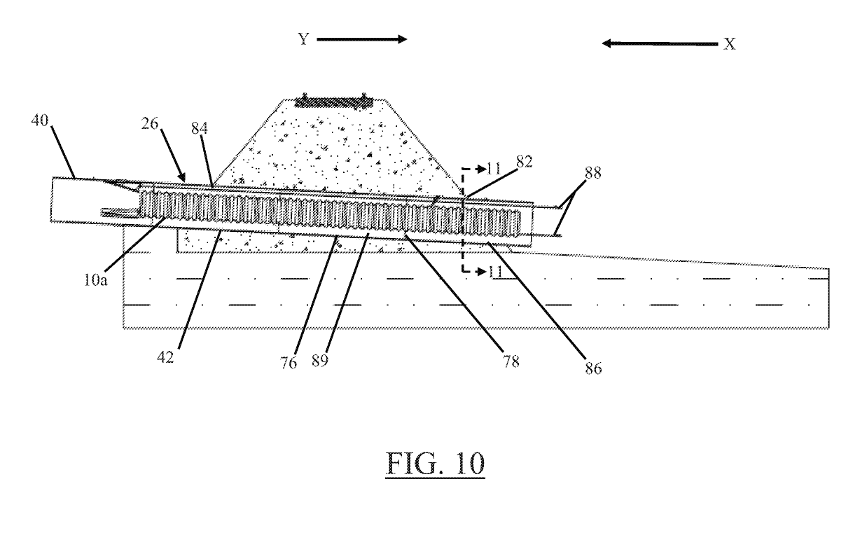

Turning now to FIG. 10, the casing 26 is shown installed in the subsurface and completely surrounding the crushed culvert 10a, The casing 26 has been driven in direction X from the entry position 82 to the exit position 84. Sections 42 and 76 have been driven through the subsurface so that section 42 has emerged from the exit position 84, Additionally, section 86 has been attached to the trailing end of section 76 at seam 78. The crushing tool section 40 has emerged from the subsurface and is positioned to be removed from section 42.

FIG. 10 shows that wire ropes 88 have been towed into the annular space between the inner surface 60 of the casing 26 and the outer surface of the crushed culvert 10a. FIG. 10 shows only two (2) wire ropes. However, a wire rope may be connected to each of the three (3) fins so that all three ropes are towed through the subsurface. As discussed briefly above, the wire ropes 88 may be connected to the towing eye 70 (FIG. 8) and pulled into the subsurface as the casing 26 is advanced in direction X. The wire ropes 88 are towed from the entry position 82 to the exit position 84 for use in pulling the crushed culvert 10a in direction Y. However, the use of wire ropes 88 to assist in removal of the crushed culvert 10a, as discussed hereinafter, is optional when crushing and replacing a culvert as disclosed hereinafter.

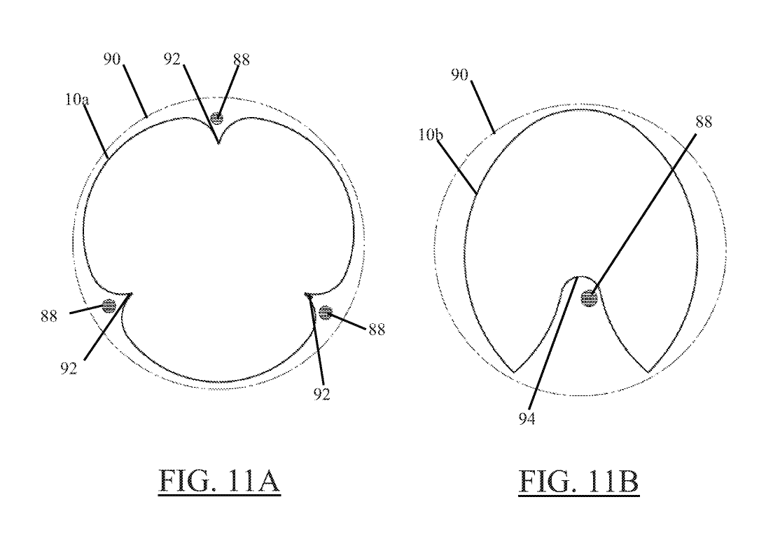

Turning now to FIG. 11A, is shown a profile of a crushed culvert 10a having an original profile represented by dashed tine 90 is shown. The culvert 10a is deformed as a result of driving the fins 30 along the length of the culvert. The path of each fin 30 is represented by a groove 92. Because each wire rope 88 is towed into the annular space 89 behind a fin 30, a wire rope will be left positioned proximate each groove 92 when the casing reaches the exit position 84 (FIG. 10).

FIG. 11B shows the deformed profile of culvert 10b where the crushing tool has only a single fin 30. The fin 30 used to create groove 94 of FIG. 11B has a radial length approximately double the radial length of the fins used to generate the lobed profile shown in FIG. 11A. The fin used in a single fin configuration has a longer radial length so that a deeper groove 94 than groove 92 may be created. When three (3) fins are used the grooves 92 may be shallower because the additive effect of the three shallow grooves will effectively reduce the contact surface of the deformed culvert 10a in FIG. 11A to the same extent as shown in FIG. 11B by the single fin configuration.

Turning now to FIG. 12, a system and method for removing the crushed culvert 10a or b from the casing will be explained. For purposes of illustration, the system and process for removing the crushed culvert will be discussed using crushed culvert 10a as an exemplar.

FIG. 12 shows a side, partially sectional, view of a system used to pull the crushed culvert 10 out of the casing 26. The system has a frame 96 supported on the first end 32 of the casing 26 and positioned to support a second drive device 97 at the first end of the casing.

A towing member 98 is shown disposed proximate the second end 34 of the casing. The towing member 98 is connected to the second drive device 97 via wire rope 88 and engages the end of crushed culvert 10a. The second drive device 97 pulls the towing member 98 in a second direction Y through the hollow region 36 of the casing 26. Putting the towing member 98 in direction Y causes the towing member to push the crushed culvert 10a out of the casing 26 through the first end 32 of the casing.

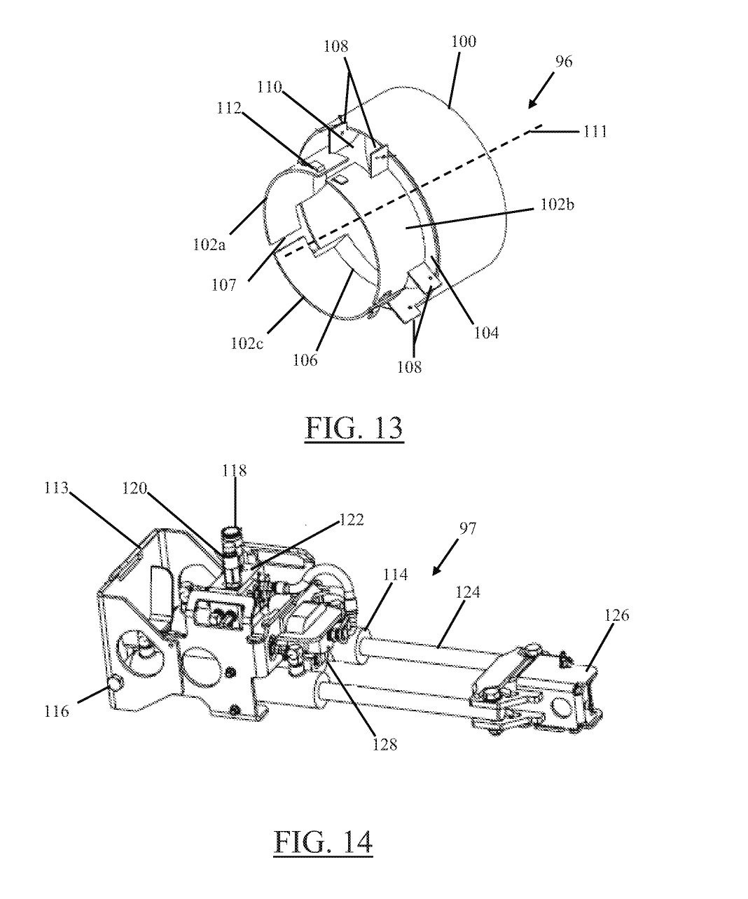

FIG. 13, shows the mounting frame 96 of FIG. 12 in greater detail. The frame 96 is made from steel and may comprise a sleeve 100 and a ring 102. The sleeve 100 has a circular profile and is sized to have an inner diameter that closely conforms to the outer diameter of the first end 32 of the casing 26, and larger than the outer diameter of the crushed culvert 10a. The sleeve 100 is generally tubular and has a length sufficient to permit the sleeve to slide into place on the casing 26 without the use of fasteners.

The ring 102 is coupled to the sleeve 100 and positioned adjacent the first end 32 of the casing 26. The ring 102 is coupled to the sleeve 100 with a flange 104. The ring 102 and sleeve 100 are aligned so that their respective longitudinal axes are coaxial. The flange 104 and ring 102 may be made from steel and welded to the sleeve 100 to form a unitary frame for supporting a plurality of second drive devices 97.

The ring 102 has an internal diameter that is less than the internal diameter of the casing 26 but larger than the outer diameter of the crushed culvert 10a. The internal diameter of the ring 102 is selected to maintain alignment between the crushed culvert 10a (FIG. 12) and the casing 26 (FIG. 12). A tapered edge 106 guides an edge of the crushed culvert 10a into the ring 102 when the culvert extraction process begins. Thus, the ring 102 has an internal diameter that permits the crushed culvert 10a to pass through the ring as it is extracted from the casing 26.

As shown in FIG. 13 the ring 102 may be comprised of three sections 102a, 102b, and 102c all connected to the sleeve 100. The sections 102a, b, and c may be connected to the sleeve so that a slit 107 is left between each section. The slits 107 permit the ring sections 102a, b, and c to flex as the second drive devices 97 pull the towing member 90 in direction Y (FIG. 12) toward the first end 32 of the casing. Such flexion will reduce the likelihood of the ring 102 breaking while under stress from the second drive devices 97. Slits 107 communicate with pockets 110 formed by the flange 104 and the sections 102a, b, and c. The slits 107 and pockets 110 form passages for the wire ropes 88.

A plurality of mounting flanges 108 may be supported on the ring sections 102a, b, and c and disposed on either side of the slits 107 and pockets 110. The mounting flanges 108 is are configured to support three (3) second drive devices 97 on the frame 96 so that they are offset 120° about a central axis 111 of the frame 96. A plurality of stabilizing tabs 112 are affixed to the ring sections 102 on both sides of the slit 107 to provide support to the second drive devices 97.

A second drive device 97 for use with frame 96 is shown in FIG. 14, The second drive device 97 may comprise a linear actuator used to apply tensile load to the wire rope 88 (FIG. 12). In a preferred embodiment, the linear actuator may comprise a hydraulically actuated linear winch having a pair of cylinders 114.

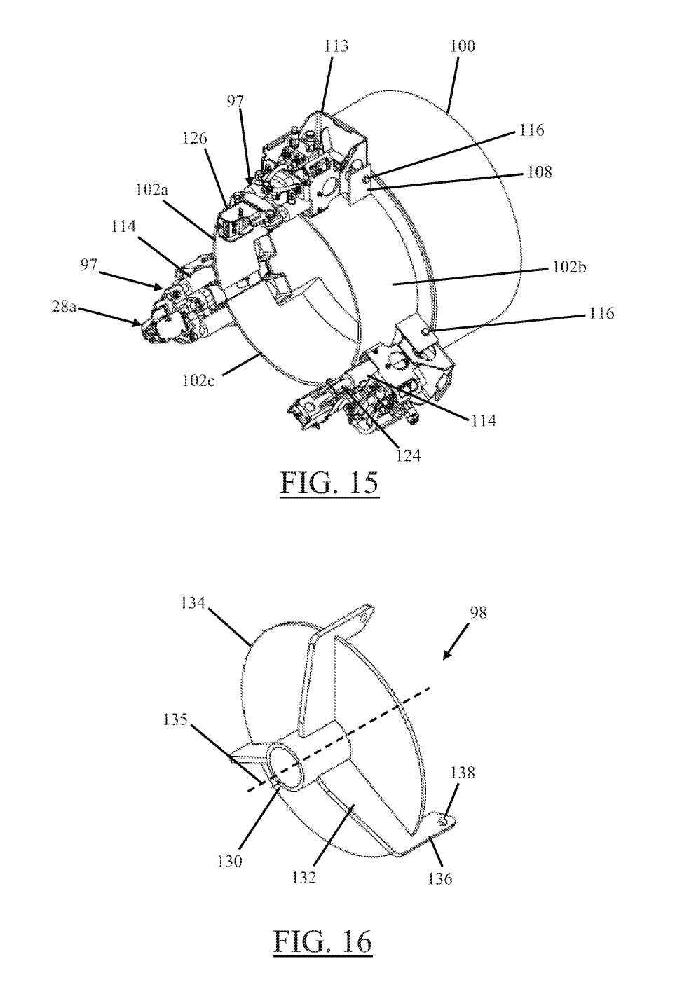

A winch frame 113 mounts the pair of hydraulic cylinders 114 to the frame 96 (FIG. 13) via bolts 116 as shown in FIG. 15. The cylinders 114 may comprise dual-action cylinders used to actuate a hand-to-hand gripping assembly of each winch. A hand-to-hand winch allows the wire rope 88 to be pulled in a linear path in direction Y (FIG. 12). Hydraulic fluid is supplied and returned to the cylinders 114 through quick connects 118 and 120 which in turn flows to control valve 122.

When hydraulic fluid is supplied from the valve 122 to the piston end of cylinders 114, rods 124 will extend and carry a rope gripping device 126 in direction Y. In a preferred arrangement the rods 124 may be extended with up to 15 tons of force. When the rods 124 are fully extended, the fluid flow is reversed to the rod side of the cylinders 114 and the rods 124. will retract. Retraction of the rods 124 will also retract the gripping device 126 causing it to release the wire rope 88. Simultaneously, a rope clamping device 128 will grip the wire rope 88 to hold it while the rope gripping device 126 is moved to a reset position for the next cylinder stroke. Repetition of this process in a cyclic manner will cause the wire rope to be passed through the linear winch and pull the crushed culvert 10a out of the casing 26 through the frame 96. FIG. 14 shows the rods 124 fully extended from the cylinders 114. However, FIG. 15 shows the rods 124 fully retracted into the cylinders 114. In this position, the rope gripping device 126 is reset. Activation of the cylinders 114 to extend the rods 124 will cause the roper gripping device 126 to grip the wire rope 88 and pull the towing member further through the casing and pull the crushed culvert 10a out of the casing 26 through the frame 96 (FIG. 12).

As shown in FIG. 12, the towing member 98 is positioned and configured to apply towing force from the wire rope 88 to the crushed culvert 10a. FIG. 16 provides a more detailed view of the towing member 98. The towing member 98 has a central tube 130, a plurality of ribs 132 projecting from the central tube, and a flange 134 supported by the ribs. The central tube 130 provides the structural backbone of the towing member 98. The ribs 132 are welded to the tube 130 and spaced about a central longitudinal axis 135 of the tube 120° degrees apart.

The ribs 132 provide structural support for the flange 134, but also have legs 136 that project parallel to the central axis 135 of tube 130. The legs 136 are sized to extend over the end of the crushed culvert 10a and fit within the grooves 92 (FIG. 11A) formed in the crushed culvert 10a The positioning of legs 136 within grooves 92 helps to maintain the flange 134 in a centered position against the crushed culvert 10a. Each leg 136 has an eye 138 for connecting the towing member 98 to one of the plurality of wire ropes 88,

The system described with reference to FIGS. 12-16 is one example of a system for removing the crushed culvert 10a from the casing 26. For example, the crushed culvert 10a may be removed by attaching a tow rope or chain to the crushed culvert and pulling the crushed culvert out of the casing with a tractor or other mobile work machine.

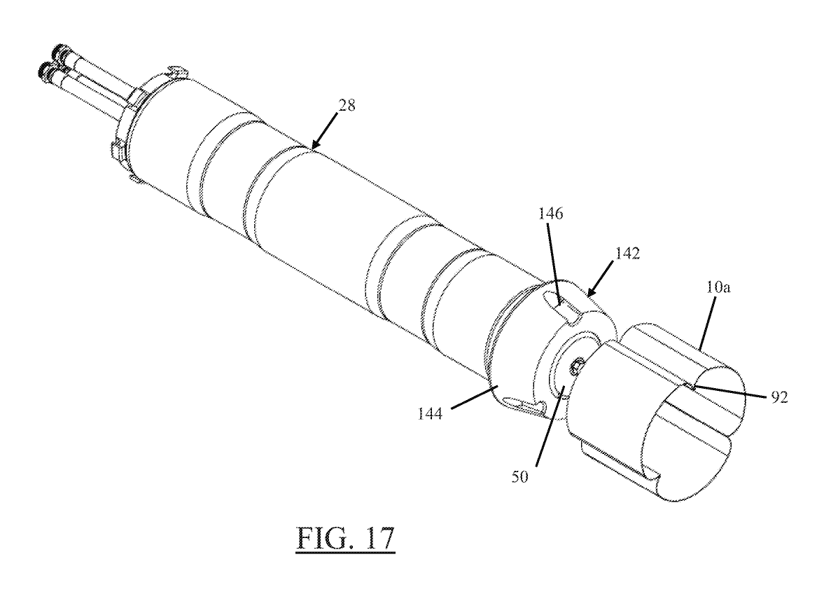

An alternative system for removing the crushed culvert 10a from the casing is shown in FIG. 17. The alternative system may comprise the drive device 28 discussed with reference to FIG. 3 having an adapter 142 supported on the tapered nose 50 of the hammer The adapter 142 has a tapered outer surface 144 and a plurality of grooves 146. Both the tapered outer surface 144 and the grooves 146 engage the features of the crushed culvert 10a (a portion of which is shown in FIG. 17). The grooves 146 are equally spaced about the circumference of the adapter 142 to mate with the grooves 92 formed in the crushed culvert 10a by the fins 30 (FIG. 3).

In operation, the device 28 is activated to drive the adapter 142 and crushed culvert 10a through and out of the casing 26. The device 28 may push the crushed culvert 10a from the entry position 82 (FIG. 7) to the exit position 84 (FIG. 7) or vice-a-versa. The device 28 will travel through the casing 26 and be supported by the casing during its operation and travel from one end of the casing to the other.

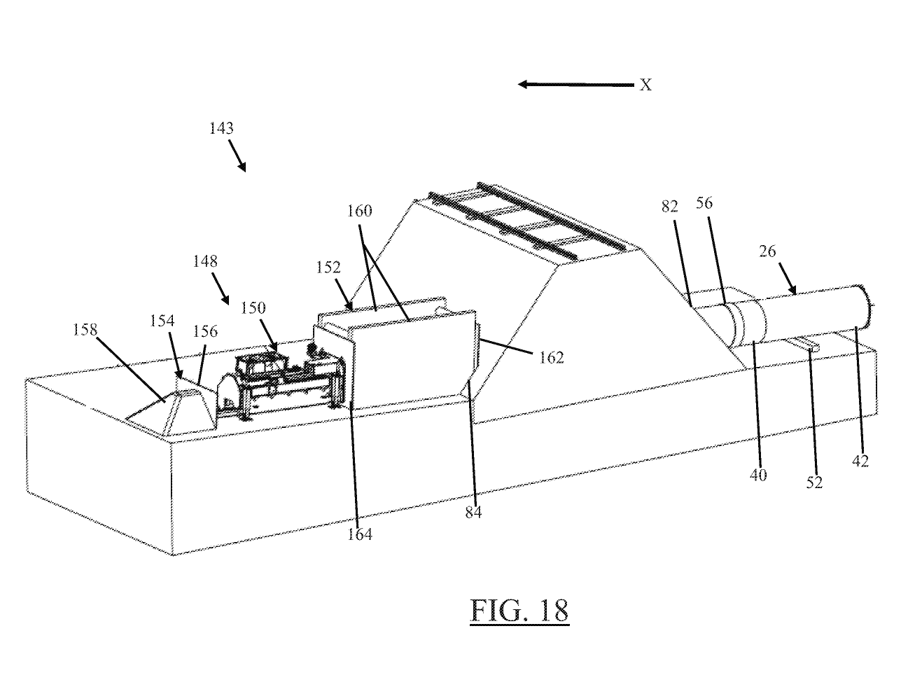

Turning now to FIG. 18 an alternative assembly 143 for installing a drainage structure comprising a casing 26 in a subsurface is shown. The assembly 143 may be used to install the casing 26 under an elevated road or railway or under an existing road or railway 14 that is not elevated. Additionally, as will be discussed hereinafter, the assembly 143 shown in FIG. 18 may be used to crush an existing culvert white the casing 26 is installed in the culvert's place.

The assembly 143 includes the casing 26 disposed on support 52 near the entry point 82 of the casing. The casing 26 may comprise section 42 and crushing toot 40. The previously discussed steel band 56 may be disposed about the crushing toot 40 to provide structural support to the tool.

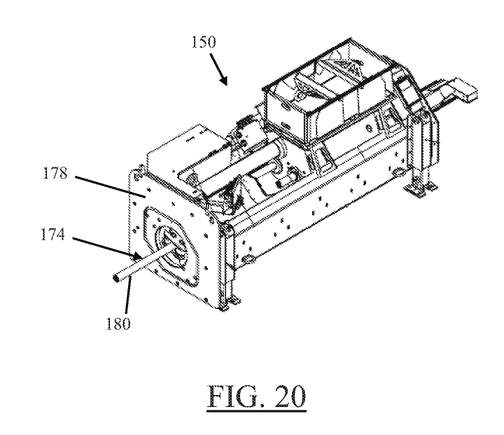

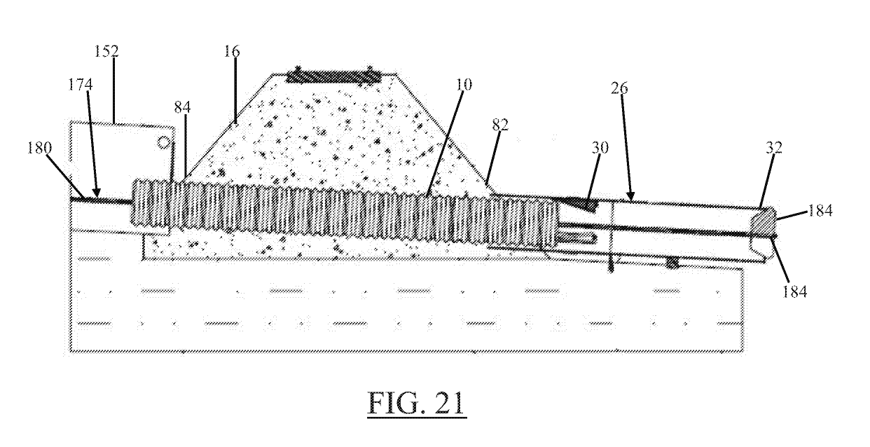

A rod putting assembly 148 is disposed near the exit position 84. The rod pulling assembly 148 comprises a rod puller 150, a trench box 152, and a reaction station 154. The rod puller 150 may be actuated by a diesel power pack (not shown) that feeds pressurized fluid to the rod puller. A suitable rod puller 150 is shown in FIG. 20 and may comprise a HammerHead® HB175 rod puller built and sold by Earth Toot Company L.L.C. The HB175 rod putter 150 can produce up to 175 tons of pulling force. The rod puller 150 is configured to configured to push a rod string 174 (FIG. 21) through the culvert 10 (FIG. 21) and then pullback the casing back through the subsurface.

The reaction station 154 comprises a vertically buried steel plate 156 that is supported by a backfill pile 158. This reaction station 154 stabilizes the rod puller 150 in direction X during operation.

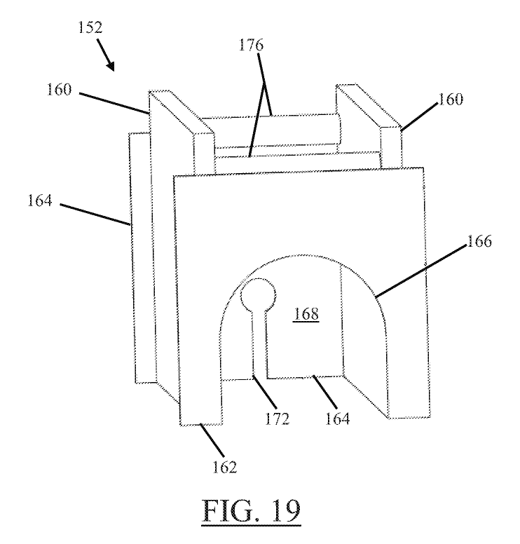

The trench box 152 is a four sided rectangle with an open top and open bottom. The sides 160 of the trench box 152 are elongate and bound by a front wall 162 and a back wall 164. As shown in FIG. 19, the front wall 162 may comprise an arch shaped opening 166 that is sized to allow crushing tool 40 or casing section 42 to pass through the front wall 162 into an interior 168 of the box 152. The back wall 164 may comprise a slot 172. The slot 172 and opening 166 permit the trench box 152 to be placed between the rod puller 150 and the exit 84 without requiring threading of the rod string 174 (FIG. 21) through the trench box 152.

The side walls 160 may be further supported by support struts 176. One strut 176 may be disposed near the front wall 162 and the other strut may be disposed near the back wall 164. The struts 176 provide additional support for the side wall to reduce the likelihood of the side walls 160 caving-in while under load from the rod puller 150.

Returning to FIG. 18, the rod puller 150 is positioned between the reaction station 154 and the back wall 164 of the trench box 152. As shown in FIG. 20, the rod putter 150 may have a reaction plate 178 configured to engage the back wall 164 during putting operations.

Turning now to FIG. 21, the assembly of FIG. 18 is shown in sectional detail. However, the rod puller 150 has been omitted to focus on the crushing elements and casing 26 shown in FIG. 21. The trench box 152 is shown at the exit position 84 partially buried and abutting the sloping side 16. The rod string 174 is shown passing through the trench box 152. The rod string 174 may be a conventional string of pipe sections connected end-to-end by threading the sections together. The rod string 174 has opposed first 180 and second 182 ends. The first end 180 is connected to the rod puller 150 (shown in FIG. 20) and the second end 182 is connected to a drive device 184.

The rod string 174 is pushed through the culvert 10 using the rod puller 150. The casing 26 is positioned around the portion of the culvert 10 that projects from the entry 82 such that fins 30 engage the culvert. The rod string is extended through the casing to project from the first end 32. The drive device 184 is inserted into the casing 26 and the second end 182 of the rod string 174 is connected to the drive device 184.

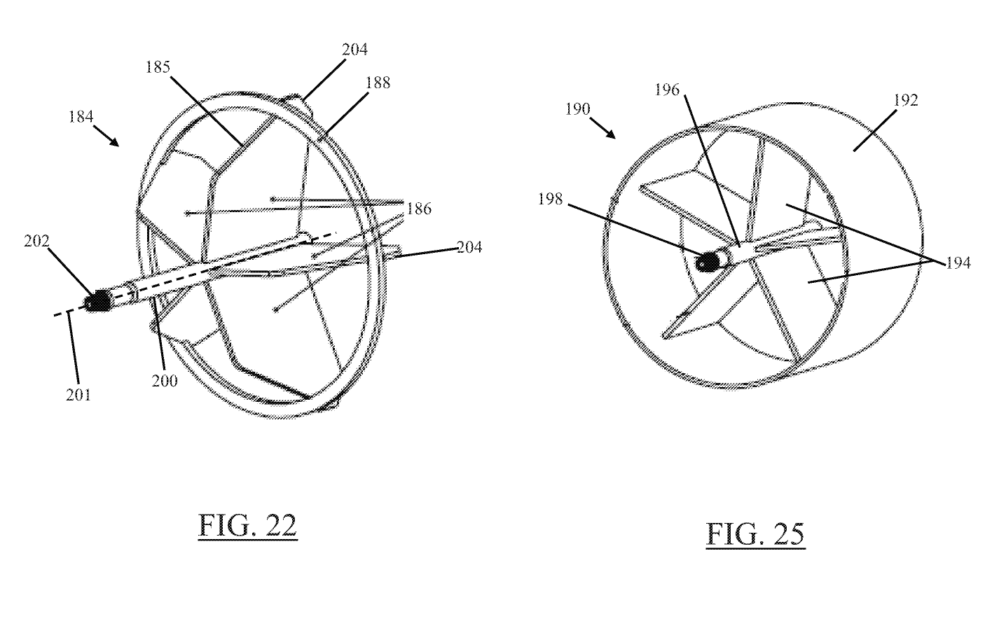

As shown in FIGS. 21 and 22, the drive device 184 may comprise a puller coupled to the first end 32 of the casing 26 at its periphery and the rod string 174 at its center. Thus, the puller 184 may have a circular profile with a tapered nose 185 formed by spokes 186 and a circular rim 188. The rim 188 abuts the circular first end 32 of the casing 26 and transfers pulling force from the rod string 174 to the casing.

FIG. 22 shows the puller 184 comprises a rim 188 having a diameter greater than the inner diameter of the casing but less than the outer diameter of the casing. Thus, the rim 188 abuts the end of the casing. A plurality of spokes 186 are welded to the rim 188 and connect the rim 188 to a hub 200. In the embodiment shown in FIG. 22, there are five (5) equally spaced about the hub 200. As shown in FIG. 22 the five (5) spokes are separated by approximately seventy-two degrees (72°) about the central longitudinal axis 201 of the hub 200. The hub 200 comprises a connection member 202 that is configured to connect the puller 184 to the second end 182 of the rod string 174.

Each spoke 186 may have a tapered edge 185 that is configured to guide the puller into the casing 26 (FIG. 21) so that the rim 188 abuts the first end 32 of the casing. The spokes 186 may also have tabs 204 that project behind the rim 188 to provide structural support for the rim. The rim 188 is welded to the spokes 186 and the spokes are welded to the hub 200.

In operation, the rod string 174 is inserted through the culvert 10 until the second end 182 of the rod string projects from the first end 32 of the casing 26. The puller 184 is connected to the second end 182 of the rod string 174 by threading the puller to the rod string at connection 202. The rod puller 150 is then activated to pull the puller 184 into the casing until the rim 188 seats against the casing 26. Once seated, the rod string 174 is pulled in direction X to pull the casing into the subsurface.

When the first end 32 of the casing 26 reaches the entry 82 action of the rod puller 150 is reversed so that the puller 184 may be disconnected from the rod string 174. Once the puller 184 has been disconnected a new casing section may be attached to the first end of the casing. After the new section is attached the rod string 174 is extended to project again from the new first end of the casing. The puller 184 is attached to the casing and pulled again in direction X. This process is repeated until the casing reaches the exit 84 position.

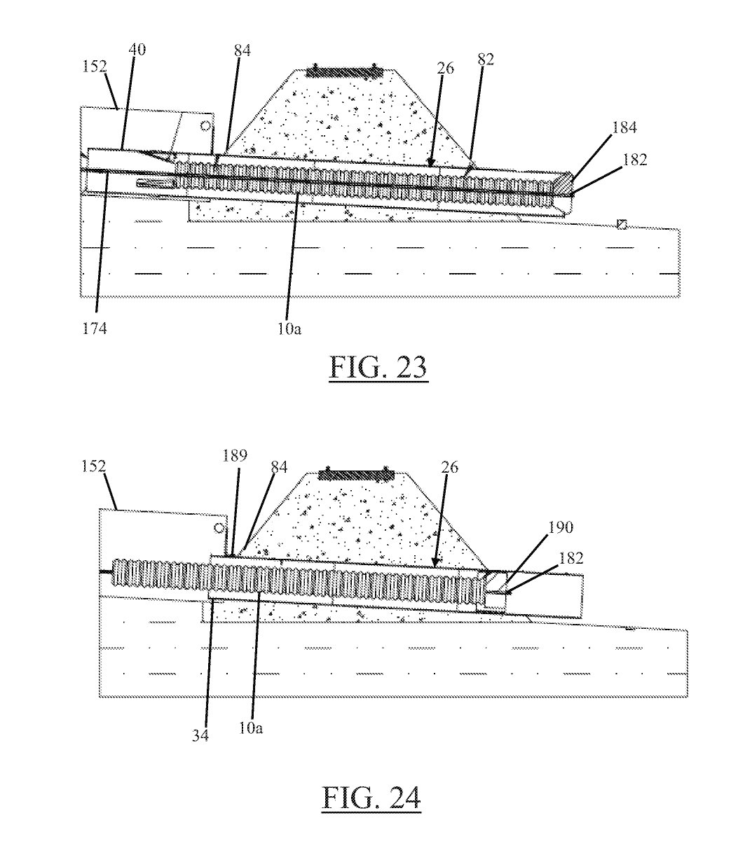

FIG. 23 shows the casing 26 pulled into the subsurface from the entry 82 to the exit 84 and the crushed culvert 10a positioned within the casing 26. The crushing tool section 40 of the casing may be disposed within the trench box 152 and removed therefrom. As illustrated in FIG. 23, when the crushing tool 40 reaches the trench box 152 the second end of the rod string is still disposed near or at the first end 32 of the casing. Thus, the rod string 174 is extended to push the puller 184 out of the casing so that the puller may be removed from the second end 182 of the rod string 174. Subsequently, a tool 190 (FIG. 25) configured to remove the crushed culvert may be connected thereto.

Turning to FIG. 24, a cleaning tool 190 comprising a sweeper puller is connected to the second end 182 of the rod string 174. As shown, the cleaning tool 190 has been pulled into the casing 26. Consequently, a portion of the crushed culvert 10a has been removed from the casing and pulled into the trench box 152. The portion of the crushed culvert 10a present within the trench box 152 may be cut from the crushed culvert 10a and removed from the trench box. This piecemeal removal of the crushed culvert 10a may continue until the entire crushed culvert has been cleared from the casing.

A restraint beam or collar 189 may be welded to the outer surface of the casing 26 at the exit 84. The restraint beam 189 may wrap a distance between one-quarter to one-half the circumference of the casing 26 around the outer surface of the second end 34 of the casing. The restraint beam 189 may be made from steel and configured to abut the front wall 162 of the trench box 152. The restraint beam 189 reduces movement of the casing 26 when load is applied to the crushed culvert 10a and the soil located between the crushed culvert and the inner surface of the casing during crushed culvert removal.

FIG. 25 shows the cleaning tool 190. The tool 190 is made from welded steel and comprises a rim 192. The rim 192 has an outer diameter that is one inch (1″) to two inches (2″) less than the inner diameter of the casing 26. Five (5) spokes 19.4 connect the rim 192 to a hub 196 disposed within the rim. The hub 196 comprises a threaded connection point 198 to connect the tool 190 to the second end 182 of the rod string 174. The spokes 194 engage the crushed culvert 10a during the extraction process.

In operation, a portion of the casing 26 is placed around an exposed portion of a drainage structure comprising the culvert 10. The casing 26 is moved through the subsurface in a first direction X from the entry position 82 to an exit position 84. The culvert 10 is enveloped by the casing 26 as the casing is moved through the subsurface in the first direction X. The culvert 10 is deformed by one or more fins 30 disposed on the inner surface of the casing 26. The fins 30 deform the drainage structure into a buckled and crushed drainage structure 10a. The buckled drainage structure may comprise the crushed culvert 10a shown in either of FIGS. 11A or 11B depending on the number of fins 30 used. The crushed culvert 10a is removed from the casing and the casing is cleaned out to allow the flow of surface water through the newly installed casing.

Various modifications and variations can be made in the present invention without departing from the scope and spirit of the invention. It is intended that the present invention cover such modifications and variations as come within the scope and spirit of the appended claims and their equivalents.

What is claimed is:

1. An assembly, comprising:
a casing having opposed first and second ends and defining a hollow region;
a drive device supported at the first end of the casing and configured to drive movement of the casing in a first direction; and
a first fin projecting from the casing into the hollow region and configured to buckle a pipe positioned at least partially within the casing when the casing is driven in the first direction.

2. The assembly of claim 1 further comprising a segmented sleeve demountably supported within the first end of the casing; and in which the drive device is partially disposed within the segmented sleeve.

3. The assembly of claim 1 in which the first fin is supported proximate the second end of the casing.

4. The assembly of claim 3 in which the first fin is supported a distance from the second end of the casing equal to approximately three times an internal diameter of the casing.

5. The assembly of claim 1 in which the first tin tapers toward the second end of the casing.

6. The assembly of claim 1 in which a second and third fin each project from the casing into the hollow region.

7. The assembly of claim 6 in which the casing is symmetric about a longitudinal axis and in which the first, second, and third fins are positioned to be offset about the longitudinal axis by an angle of 120 degrees.

8. The assembly of claim 1 further comprising a frame supported on the first end of the casing and positioned to support the drive device.

9. The assembly of claim 8 in which the frame comprises a sleeve disposed around the first end of the casing; and a ring coupled to the sleeve and positioned adjacent the first end of the casing.

10. The assembly of claim 9 further comprising a towing member and a second drive device; in which the second drive pulls the towing member in a second direction through the hollow region of the casing.

11. The assembly of claim 10 in which the towing member has a central tube, a rib projecting from the central tube, and a flange supported by the rib.

12. The assembly of claim 10 further comprising a wire rope connected to the towing member and the second drive device.

13. The assembly of claim 9 further comprising a towing member and second drive device; in which the second drive device is supported on the ring and connected to the towing member.

14. The assembly of claim 10 in which the towing member engages the pipe and pushes the pipe out of the casing through the first end of the casing.

15. The assembly of claim 1 further comprising:
a rod puller; and
a rod string disposed within the pipe and the hollow region, the rod string having opposed first and second ends, in which the first end is connected to the rod puller and the second end is connected to the drive device

16. The assembly of claim 15 wherein the drive device is a puller demountably supported at the first end of the casing and configured to engage a periphery of the casing.

17. A method, comprising:
placing a portion of a casing around an exposed portion of a drainage structure;
moving the casing through a subsurface in a first direction from an entry position to an exit position;
enveloping the drainage structure with the casing as the casing is moved through the subsurface in the first direction;
deforming the drainage structure into a buckled drainage structure as the casing envelops the drainage structure using a first fin positioned within the casing; and
removing a buckled drainage structure from the casing.

18. The method of claim 17 in which moving the casing through the subsurface in a first direction is accomplished by pushing the casing using a hammer

19. The method of claim 17 in which the buckled drainage structure has a maximum cross-sectional dimension less than the cross-sectional dimension of the drainage structure before it is deformed.

20. The method of claim 19 in which a second and third fin are used with the first fin to deform the drainage structure, wherein the buckled drainage structure has a lobed cross-sectional profile.
